(19) United States
(12) Patent Application Publication
(10) Pub. No.: US 2010/0277099 A1
(43) Pub. Date: Nov. 4, 2010

(54) METHOD OF DRIVING A LIGHT SOURCE, LIGHT SOURCE DRIVING APPARATUS FOR PERFORMING THE METHOD AND DISPLAY APPARATUS HAVING THE LIGHT SOURCE DRIVING APPARATUS

(76) Inventors: Kyung-Uk CHOI, Chungcheongnam-do (KR); Jong-Jae LEE, Chungcheongnam-do (KR); Seung-Hwan MOON, Chungcheongnam-do (KR)

Correspondence Address: Innovation Counsel LLP, 21771 Stevens Creek Blvd, Ste. 200A, Cupertino, CA, 95014, US

(21) Appl. No.: 12/564,826

(22) Filed: Sep. 22, 2009

(30) Foreign Application Priority Data
Apr. 30, 2009 (KR) 2009-0037959

(51) Int. Cl. H05B 37/02; H05B 39/04

(52) U.S. Cl. 315/297; 315/307

(57) ABSTRACT

A light source power supply part generates a first output voltage close to a light source input voltage or a second output voltage close to a reference voltage by comparing the reference voltage and the light source input voltage in accordance with an embodiment of the present invention. A light source driving part may drive a light source based on the first output voltage or the second output voltage. Therefore, the light source may be driven with a stable voltage regardless of the level of the light source input voltage.

### PRIORITY STATEMENT

This application claims priority under 35 U.S.C. §119 to Korean Patent Application No. 2009-37959, filed on Apr. 30, 2009 in the Korean Intellectual Property Office (KIPO), the contents of which are herein incorporated by reference in their entirety.

### BACKGROUND

1. Technical Field

One or more embodiments of the present invention relate to a method of driving a light source, a light source driving apparatus for performing the method, and a display apparatus having the light source driving apparatus. More particularly, one or more embodiments of the present invention relate to a method of driving a light source with a stable voltage, a light source driving apparatus for performing the method, and a display apparatus having the light source driving apparatus.

2. Description of the Related Art

Generally, a flat panel display apparatus such as a liquid crystal display (LCD) apparatus includes an LCD panel that displays images using the light transmittance property of liquid crystal molecules, and a backlight unit disposed under the LCD panel to provide the LCD panel with light.

The LCD panel includes an array substrate, a color filter substrate, and a liquid crystal layer interposed between the array substrate and the color filter substrate. The array substrate includes a plurality of pixel electrodes and a plurality of thin-film transistors (TFTs) electrically connected to the pixel electrodes. The color filter substrate includes a common electrode and a plurality of color filters.

When an electric field formed between the pixel electrodes and the common electrode is applied to the liquid crystal layer, the arrangement of liquid crystal molecules of the liquid crystal layer is altered so that the light transmittance through the liquid crystal layer is varied, resulting in display of varying luminance. For example, when the light transmittance is increased to a maximum level, the LCD panel may display a white image having high luminance. Conversely, when the light transmittance is decreased to a minimum level, the LCD panel may display a black image having low luminance.

Recently, in order to decrease the amount of light from the backlight unit and to increase the amount of light transmitted through pixels of the LCD panel, a dimming method has been developed. The dimming method is initially developed for backlight units with a light-emitting diode (LED) module having LEDs as the light source, but the dimming method is also being increasingly applied to backlight units with a lamp module. In the backlight unit using the dimming method, the backlight unit is divided into a plurality of light source blocks where each light source block may include arrays of the light sources, and image areas corresponding to the light source blocks are analyzed to control a luminance for each of the light source blocks. The LCD panel is driven in accordance with an increased gradation level of the analyzed image areas so as to increase the light transmittance through pixels of the LCD panel, and the backlight unit is driven in accordance with a reduction in the luminance of the light source blocks to compensate for the amount of increase of the gradation level.

However, input voltages applied to the light source blocks from a power source such as a battery or an adapter may increase or decrease as a function of the voltage fluctuation of the power source. In this case, the reduction in the luminance of the light source blocks may not be reliably performed in synchronization with the increased light transmittance of the LCD panel. For example, one of the input voltages from the battery or the adapter may not turn on LEDs in each of the light source blocks, thus degrading the quality of the displayed image.

### SUMMARY

One or more embodiments of the present invention provide a method of driving a light source stably regardless of the level of a light source input voltage.

One or more embodiments of the present invention also provide a light source driving apparatus for performing the above-mentioned method.

One or more embodiments of the present invention also provide a display apparatus having the above-mentioned apparatus.

According to one or more embodiments of the present invention, there is provided a method of driving a light source. In the method, a reference voltage is compared with the light source input voltage to generate a first output voltage close to the light source input voltage or a second output voltage close to the reference voltage. Then, the light source is driven based on the first output voltage or the second output voltage.

In one or more embodiments of the present invention, the first output voltage may be generated when the light source input voltage is substantially less than the reference voltage, and the second output voltage may be generated when the light source input voltage is greater than or equal to the reference voltage.

In one or more embodiments of the present invention, in generating the second output voltage, the reference voltage may be compensated so a difference between the second output voltage and the reference voltage is reduced.

In one or more embodiments of the present invention, the first output voltage may be boosted to generate a third output voltage, and the second output voltage may be boosted to generate a fourth output voltage. In this embodiment, the light source may be performed based on one of the first to fourth output voltages.

According to one or more embodiments of the present invention, a light source driving apparatus includes a light source power supply part and a light source driving part. The light source power supply part compares a reference voltage and a light source input voltage to generate a first output voltage close to the light source input voltage or a second output voltage close to the reference voltage. The light source driving part drives a light source based on the first output voltage or the second output voltage.

In one or more embodiments of the present invention, the light source power supply part may generate the first output voltage when the light source input voltage is substantially less than the reference voltage, and may generate the second output voltage when the light source input voltage is greater than or equal to the reference voltage.

In one or more embodiments of the present invention, the light source power supply part may include a switching element and a Zener diode. The switching element may include an input terminal configured to receive the light source input voltage, a control terminal, and an output terminal connected to the light source driving part. The Zener diode may include an anode connected to a ground terminal, and a cathode connected to the control terminal of the switching element.

In one or more embodiments of the present invention, the reference voltage may be a breakdown voltage of the Zener diode.

In one or more embodiments of the present invention, the light source driving apparatus may further include a resistor connected between the input terminal and the control terminal of the switching element.

In one or more embodiments of the present invention, the light source driving apparatus may further include a capacitor connected between the output terminal of the switching element and the ground terminal.

In one or more embodiments of the present invention, the light source power supply part may include a switching element, a first diode and a Zener diode. The switching element may include an input terminal configured to receive the light source input voltage, a control terminal, and an output terminal connected to the light source driving part. The first diode may be connected to the control terminal of the switching element. The Zener diode may include an anode connected to a ground terminal, and a cathode connected to the first diode.

In one or more embodiments of the present invention, the cathode of the Zener diode may be connected to a cathode of the first diode.

In one or more embodiments of the present invention, the reference voltage may be a total voltage of a breakdown voltage of the Zener diode and a compensation voltage. In this case, the reference voltage may be compensated by the first diode.

In one or more embodiments of the present invention, the light source power supply part may further include a second diode connected between the input terminal of the switching element and the output terminal of the switching element.

In one or more embodiments of the present invention, the light source driving apparatus may further include a resistor connected between the input terminal of the switching element and the control terminal of the switching element.

In one or more embodiments of the present invention, the light source driving apparatus may further include a capacitor connected between the output terminal of the switching element and the ground terminal.

In one or more embodiments of the present invention, the light source driving apparatus may further include a booster circuit configured to generate a third output voltage and a fourth output voltage by boosting the first output voltage and the second output voltage, respectively. The light source driving part may drive the light source based on one of the first to fourth output voltages.

In one or more embodiments of the present invention, the light source driving part may include a switching-mode power supply (SMPS). The booster circuit may include an inductor and a third diode. The inductor may be connected between the light source power supply part and the SMPS. The third diode may include an anode connected to the SMPS and the inductor, and a cathode connected to the light source.

According to one or more embodiments of the present invention, a display apparatus includes a display module and a backlight assembly. The display module receives light to display an image. The backlight assembly includes a light source part, a light source power supply part and a light source driving part. The light source part includes a plurality of light source blocks to provide the light to the display module. The light source power supply part compares a reference voltage and a light source input voltage to generate a first output voltage close to the light source input voltage or a second output voltage close to the reference voltage. The light source driving part drives the light source part based on the first output voltage or the second output voltage.

In one or more embodiments of the present invention, the light source block may include a plurality of light-emitting diodes (LEDs). The light source blocks may be arranged in a longitudinal or a latitudinal direction corresponding to the display module.

According to one or more embodiments of the present invention on a method of driving a light source, a light source driving apparatus for performing the method, and a display apparatus having the light source driving apparatus, a light source may be driven with a stable voltage regardless of the level of a light source input voltage because a second output voltage that is substantially less than or close to a reference voltage is boosted to drive the light source even though the level of the light source input voltage is great regardless of the number of LEDs.

### BRIEF DESCRIPTION OF THE DRAWINGS

One or more embodiments of the present invention will be more clearly understood from the following detailed description taken in conjunction with the accompanying drawings, in which.

FIG. 1 is a block diagram illustrating a display apparatus according to one or more embodiments of the present invention;

FIG. 2 is a circuit diagram illustrating a backlight assembly in FIG. 1 according to one or more embodiments of the present invention;

FIGS. 3A to 3C are waveform diagrams illustrating voltages applied to a control terminal, an input terminal, and an output terminal of a light source power supply part of FIG. 2 according to one or more embodiments of the present invention;

FIG. 4 is a flowchart illustrating a method of driving a light source driving apparatus of FIG. 1 according to one or more embodiments of the present invention;

FIG. 5 is a circuit diagram illustrating a backlight assembly according to another embodiment of the present invention;

FIGS. 6A to 6C are waveform diagrams illustrating voltages applied to a control terminal, an input terminal, and an output terminal of a light source power supply part of FIG. 5 according to one or more embodiments of the present invention; and

FIG. 7 is a flowchart illustrating a method of driving the light source driving apparatus of FIG. 5 according to one or more embodiments of the present invention.

### DETAILED DESCRIPTION

Embodiments of the present invention are described more fully hereinafter with reference to the accompanying drawings, in which one or more embodiments of the present invention are shown. The present invention may, however, be embodied in many different forms and should not be construed as being limited to the embodiments set forth herein. Rather, the scope of the present invention will only be defined by the appended claims. In the drawings, the sizes and relative sizes of elements may be exaggerated for clarity.

It will be understood that, although the terms first, second, third, etc. may be used herein to describe various elements, these elements should not be limited by these terms. These terms are only used to distinguish one element from another. Thus, a first element discussed below could be termed a second element without departing from the teachings of the present invention.

The terminology used herein is for the purpose of describing particular embodiments of the present invention only and is not intended to be limiting of other embodiments of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as it is commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be explained in detail with reference to the accompanying drawings.

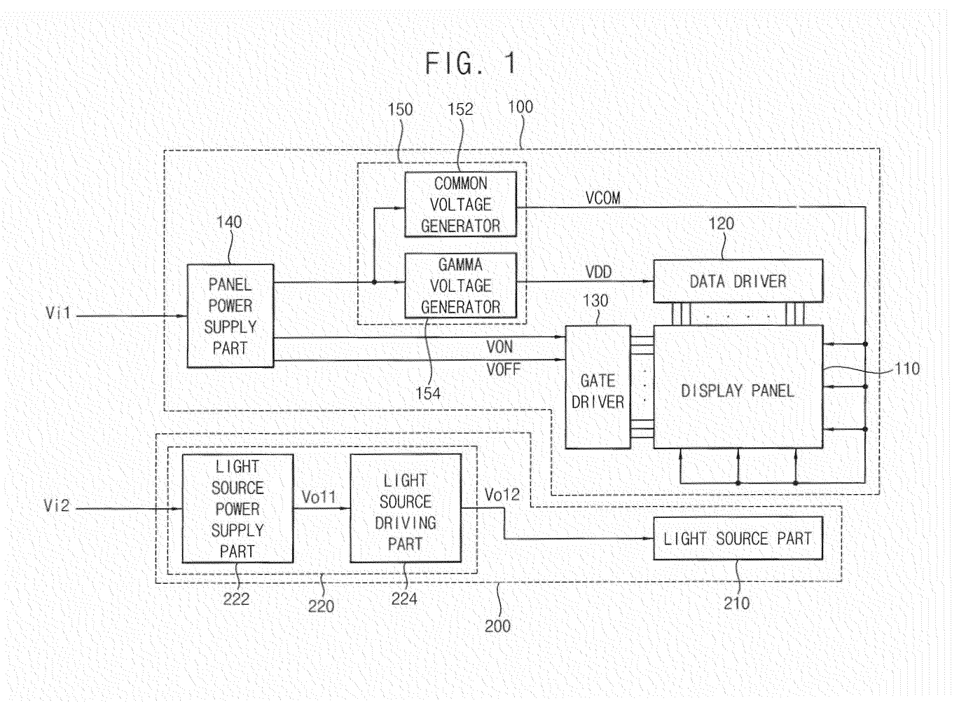

FIG. 1 is a block diagram illustrating a display apparatus according to one or more embodiments of the present invention. Referring to FIG. 1, the display apparatus includes a panel module 100 and a backlight assembly 200. The panel module 100 includes a display panel 110, a data driver 120, a gate driver 130, a panel power supply part 140, and a voltage convert part 150. An external battery (not shown) or an external adapter (not shown) directly provides a panel input voltage Vi1 to the panel power supply part 140. The panel power supply part 140 provides a first direct-current (DC) voltage including a gate-on voltage VON and a gate-off voltage VOFF to the gate driver 130 by converting the panel input voltage Vi1 into the first DC voltage. The voltage convert part 150 includes a common voltage generator 152 and a gamma voltage generator 154. The common voltage generator 152 receives the first DC voltage to generate a common voltage VCOM and provides the display panel 110 with the common voltage VCOM. Similarly, the gamma voltage generator 154 receives the first DC voltage to generate a gamma voltage VDD and provides the data driver 120 with the gamma voltage VDD.

The data driver 120 provides the display panel 110 with a gradation display voltage corresponding to a data gradation level based on the gamma voltage VDD. The first DC voltage from which the data gradation level has been converted may be a gamma reference voltage.

The display panel 110 displays images by providing a liquid crystal layer (not shown) with the gradation display voltage and the common voltage VCOM based on the gate-on/off voltages VON/VOFF from the gate driver 130. The liquid crystal layer is disposed between an upper substrate (not shown) and a lower substrate (not shown) of the display panel 110. The gradation display voltage is provided from the data driver 120, and the common voltage VCOM is provided from the common voltage generator 152.

The backlight assembly 200 includes a light source part 210 and a light source driving apparatus 220. The light source part 210 includes a plurality of light source blocks. The light source driving apparatus 220 includes a light source power supply part 222 and a light source driving part 224.

The light source power supply part 222 receives a light source input voltage Vi2 from the external battery or the external adapter. In one or more embodiments, the external battery may output power voltage of from about 8 V through about 13.2 V to the light source power supply part 222. In other embodiments, the external adapter may output power voltage of about 19.5 V to the light source power supply part 222.

The light source power supply part 222 converts the light source input voltage Vi2 into a second DC voltage Vo11 to provide the light source driving part 224 with the second DC voltage Vo11.

A level of the second DC voltage Vo11 may be varied in accordance with the light source input voltage Vi2. For example, the light source power supply part 222 may output the second DC voltage Vo11 as a first output voltage at a level close to the light source input voltage Vi2 when the light source input voltage Vi2 is substantially less than a first reference voltage Vref1. On the other hand, the light source power supply part 222 may output the second DC voltage Vo11 as a second output voltage at a level close to the first reference voltage Vref1 when the light source input voltage Vi2 is greater than or equal to the first reference voltage Vref1.

A third DC voltage Vo12 is an output voltage from the light source driving part 224 that is boosted from the second DC voltage Vo11 to be provided to the light source part 210. For example, the third DC voltage Vo12 may include a third output voltage boosted from the first output voltage, and a fourth output voltage boosted from the second output voltage.

The light source driving part 224 determines a luminance representative value in accordance with an external image signal (not shown) corresponding to each light source block of the light source part 210, and generates driving signals based on the third DC voltage Vo12 according to a dimming level of each light source block corresponding to the luminance representative value.

For example, the light source driving part 224 divides the image signal in a frame unit into a plurality of image blocks and, from the image signal, obtains a maximum gradation data and an average gradation data of each of the image blocks. Then, the light source driving part 224 determine the luminance representative value of each image block based on the maximum gradation data and the average gradation data. Then, the light source driving part 224 determines dimming level duty ratios for each light source block of the light source part 210 based on the luminance representative value of the corresponding image block. At this time, the light source driving part 224 generates the driving signals based on the dimming level duty ratios to provide the light source part 210 with the driving signals. Each light source block of the light source part 210 generates light based on the driving signals. The display panel 110 then displays the image signals by receiving the light from the light source part 210.

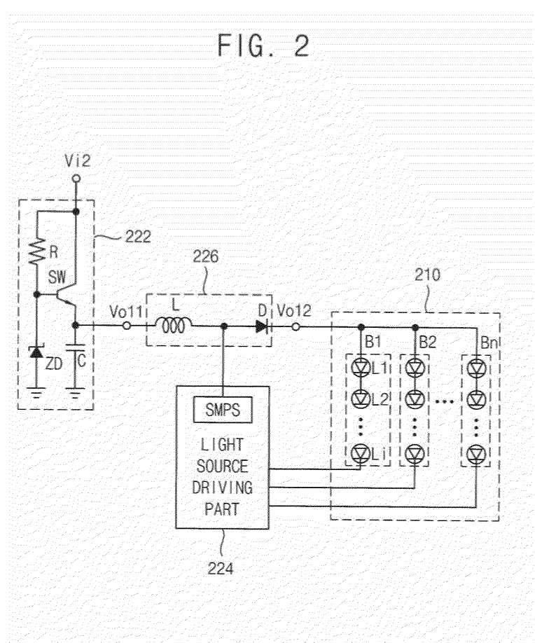

FIG. 2 is a circuit diagram illustrating a backlight assembly of FIG. 1 according to one or more embodiments of the present invention.

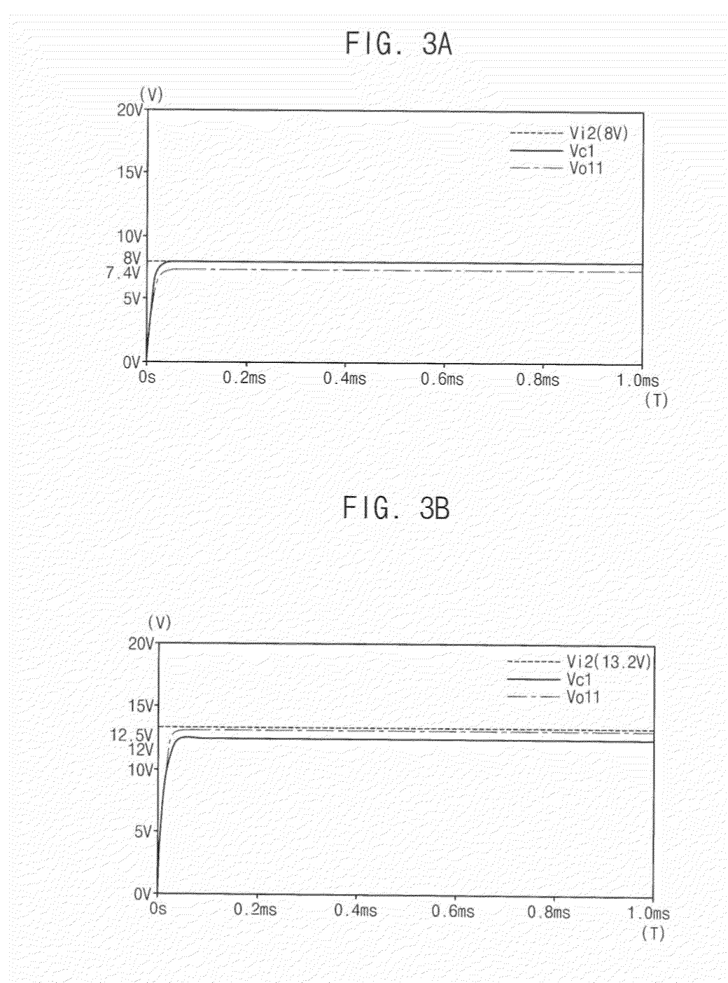

FIGS. 3A to 3C are waveform diagrams illustrating voltages applied to a control terminal, an input terminal, and an output terminal of the light source power supply part 222 of FIG. 2 according to one or more embodiments of the present invention. In FIGS. 3A to 3C, a horizontal axis (i.e., x-axis) represents time T, and a vertical axis (i.e., y-axis) represents voltage V.

Referring to FIGS. 1 to 3C, the light source power supply part 222 includes a resistor R, a Zener diode ZD, a switching element SW, and a capacitor C. The Zener diode ZD has a breakdown voltage which is the first reference voltage Vref1.

The switching element SW includes an input terminal receiving the light source input voltage Vi2, a control terminal connected to a cathode of the Zener diode ZD, and an output terminal outputting the second DC voltage Vo11. The resistor R is connected between the input terminal and the control terminal. A first end of the capacitor is connected to the output terminal. An anode of the Zener diode ZD and a second terminal of the capacitor C are grounded.

When the light source input voltage Vi2 is applied to the switching element SW, a value close to the light source input voltage Vi2 or a value close to the reference value Vref is generated as the first DC voltage Vo11 in accordance with the magnitude of the light source input voltage Vi2.

For example, the switching element SW outputs the value close to the light source input voltage Vi2 as the first output voltage when the switching element SW receives the light source input voltage Vi2 at a level that is substantially less than the first reference voltage Vref1.

On the other hand, the switching element SW outputs the value close to the first reference voltage Vref1 as the second output voltage when the switching element SW receives the light source input voltage Vi2 at a level that is greater than or equal to the first reference voltage Vref1.

The light source driving part 224 includes a switching-mode power supply (SMPS).

The light source driving apparatus 220 may further include a booster circuit 226 connected to the SMPS to boost the first output voltage and the second output voltage to the third output voltage and the fourth output voltage, respectively. The booster circuit 226 may include an inductor L and a diode D.

The output terminal of the switching element SW is connected to a first end of the inductor L. The light source part 210 is connected to a cathode of the diode D. A second end of the inductor L and an anode of the diode D are connected to the SMPS.

Therefore, the second DC voltage Vo11 from the output terminal of the switching element SW may be boosted into the third DC voltage Vo12 having a level for use by the light source part 210. In this case, the light source part 210 may use the third DC voltage Vo12 without having to boost the second DC voltage Vo11.

The light source part 210 includes a plurality of light source blocks B1 through Bn. Each of the light source blocks B1 through Bn includes a plurality of light sources L1 through Li. Here, ‘i’ and ‘n’ are natural numbers. The light source includes a plurality of light-emitting diodes (LEDs).

The light source blocks B1 through Bn are turned on or turned off by block unit in response to the driving signals. The light source blocks B1 through Bn may be driven through a one-dimensional (1D) local dimming method in which the light source blocks B1 through Bn are divided and driven with respect to a longitudinal or a latitudinal direction.

According to an embodiment of the present invention, the 1D dimming method used in the backlight assembly 200 is explained. However, a two-dimensional (2D) dimming method may be used in the backlight assembly 200, in which the light source blocks B1 through Bn are divided into matrix blocks and driven with respect to the divided matrix blocks. Alternatively, the light source part 210 may be driven through a zero-dimensional (0D) dimming method in which each block unit of light source may be one light source block.

Therefore, a voltage which drives the light sources L1 through Li has to be applied to the light source blocks B1 through Bn by block unit. In this case, the voltage capable of driving the light sources L1 through Li is the third DC voltage Vo12 corresponding to the light sources L1 through Li.

For example, each of the light sources L1 through Li uses from about 3 V to about 3.4 V when the light sources L1 through Li are turned on. Therefore, the third DC voltage Vo12 is from about 15 V to about 17 V when ‘i’ is 5, and the third DC voltage Vo12 is from about 18 V to about 20.4 V when ‘i’ is 6. Alternatively, the third DC voltage Vo12 is from about 21 V to about 23.8 V when ‘i’ is 7, and the third DC voltage Vo12 is from about 24 V to about 27.2 V when ‘i’ is 8. Alternatively, the third DC voltage Vo12 is from about 27 V to about 30.6 V when ‘i’ is 9, and the third DC voltage Vo12 is from about 30 V to about 34 V when ‘i’ is 10. The light source driving part 224 may turn on or turn off the light source blocks B1 through Bn by block unit.

As mentioned, the battery outputs from about 8 V to about 13.2 V, and the adapter outputs about 19.5 V as the light source input voltage Vi2. The third DC voltage Vo12 may be about 15 V when ‘i’ is 5. Therefore, the first reference voltage Vref1 may be from about 10 V to about 15 V. In one embodiment of the present invention, the reference voltage Vref1 is about 12 V.

In this embodiment, the second DC voltage Vo11 may have a value close to the first reference voltage Vref1. Thus, the second DC voltage Vo11 passing through the light source driving part 224 and the booster circuit 226 may be boosted into the third DC voltage Vo12 capable of turning on the light sources L1 through Li. Alternatively, the second DC voltage Vo11 may be outputted as the third DC voltage Vo12 which is not boosted. In this embodiment, when over five of the light sources L1 through Li are turned on, the third DC voltage Vo12 is greater than the first reference voltage Vref1. Thus, the booster circuit 226 connected to the SMPS in the light source driving part 224 has a boosting function.

In the present embodiment, over five of the light sources L1 through Li are shown in a light source block; however, the number of light sources L1 through Li in a light source block may be from about 4 to about 12.

When less than five light sources L1 through Li are turned on, the level of the first reference voltage Vref1 may be substantially less than the level of the first reference voltage Vref1 corresponding to a light source block with greater than or equal to five light sources L1 through Li.

Referring to FIGS. 3A to 3C again, a change of the second DC voltage Vo11 according to the level of the light source input voltage Vi2 is shown when the first reference voltage Vref1 is about 12 V.

For example, in FIG. 3A, the light source input voltage Vi2 is substantially less than the first reference voltage Vref1, which is the breakdown voltage, when the light source input voltage Vi2 of about 8 V is applied to the input terminal of the switching element SW of FIG. 2. Thus, the Zener diode Zd is turned off. Therefore, a voltage Vc1 applied to the Zener diode ZD, and the first output voltage, which is the second DC voltage Vo11, increase for about 0.03 ms after the light source input voltage Vi2 is applied, and reach about 8 V and about 7.4 V, respectively.

In FIG. 3B, the light source input voltage Vi2 is greater than the first reference voltage Vref1, which is the breakdown voltage, when the light source input voltage Vi2 of about 13.2 V is applied to the input terminal of the switching element SW. Thus, the Zener diode Zd is turned on. Therefore, the voltage Vc1 applied to the Zener diode ZD increases for about 0.03 ms after the light source input voltage Vi2 is applied, and reaches about 12 V, which is the breakdown voltage. The second output voltage, which is the second DC voltage Vo11, also increases for about 0.03 ms after the light source input voltage Vi2 is applied and becomes close to 12 V, which is the breakdown voltage. In this case, the second output voltage finally becomes about 12.5 V, which is 0.5 V greater than the breakdown voltage.

In FIG. 3C, the light source input voltage Vi2 is also greater than the first reference voltage Vref1, which is the breakdown voltage, when the light source input voltage Vi2 of 19.5 V is applied to the input terminal of the switching element SW. Thus, the Zener diode Zd is turned on. Therefore, the voltage Vc1 applied to the Zener diode ZD increases for about 0.03 ms after the light source input voltage Vi2 is applied, and reaches about 12 V, which is the breakdown voltage. The second output voltage, which is the second DC voltage Vo11, also increases for about 0.03 ms after the light source input voltage Vi2 is applied and becomes close to 12 V, which is the breakdown voltage. In this case, the second output voltage finally becomes about 12.5 V, which is 0.5 V greater than the breakdown voltage.

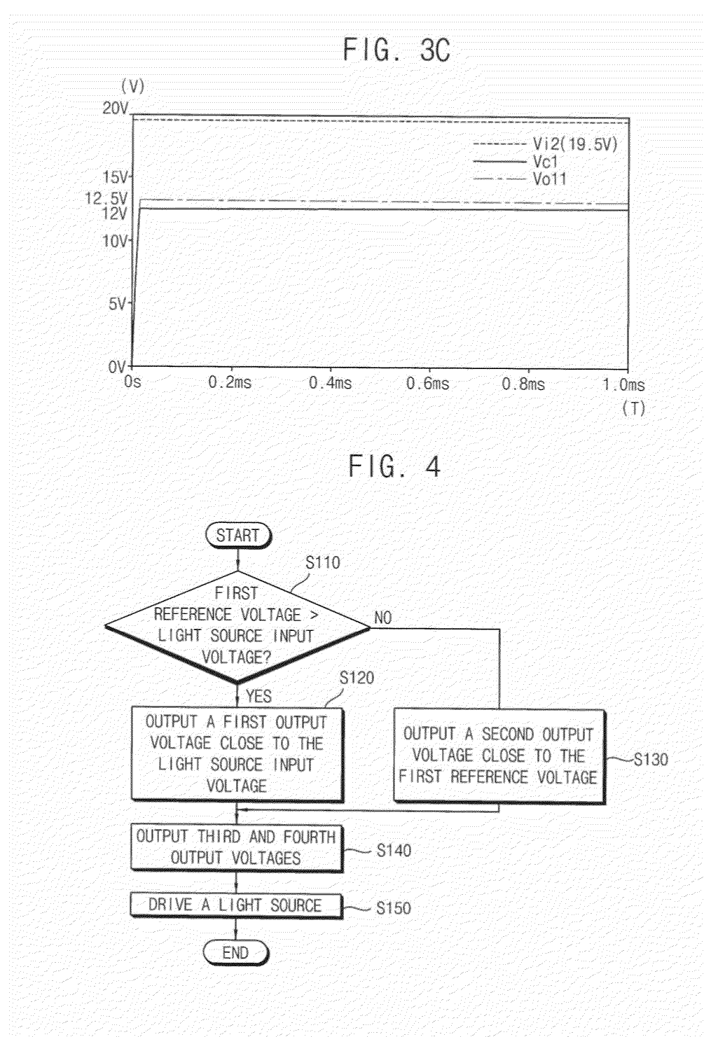

FIG. 4 is a flowchart illustrating a method of driving the light source driving apparatus 220 of FIG. 1 according to one or more embodiments of the present invention.

Referring to FIGS. 1 and 4, the first reference voltage Vref1, which is the breakdown voltage of the Zener diode ZD, and the light source input voltage Vi2 are compared when the light source input voltage Vi2 is applied to the input terminal of the switching element SW (step S110).

Then, when the light source input voltage Vi2 is found to be substantially less than the first reference voltage Vref1, the first output voltage, which is the second DC voltage Vo11 at a level close to the light source input voltage Vi2, is generated (step S120). On the other hand, when the light source input voltage Vi2 is found to be greater than or equal to the first reference voltage Vref1, the second output voltage, which is the second DC voltage Vo11 at a level close to the first reference voltage Vref1, is generated (step S130).

The second DC voltage Vo11 is boosted into the third DC voltage Vo12, which includes the third and fourth output voltages, by the SMPS in the light source driving part 224 connected between the inductor L and the diode D of FIG. 2 (step S140). In this case, the third DC voltage Vo12 may also include the first and second output voltages. Therefore, the light source driving part 224 drives the light source part 210 based on the third DC voltage Vo12 (step S150).

According to one or more embodiments of the present invention, the light source power supply part 222 outputs the second DC voltage Vo11 having a level close to the light source input voltage Vi2 when Vi2 is less than the first reference voltage Vref1, or having a level of the first reference voltage Vref1 when Vi2 is greater than or equal to the Vref1 regardless of the voltage level of the light source input voltage Vi2. Thus, only a boosting circuit may be used for turning on the LEDs regardless of the number of the LEDs. Therefore, the display apparatus according to one or more embodiments of the present invention may use the battery or the adapter applying a variety of voltage levels on the light source input voltage Vi2.

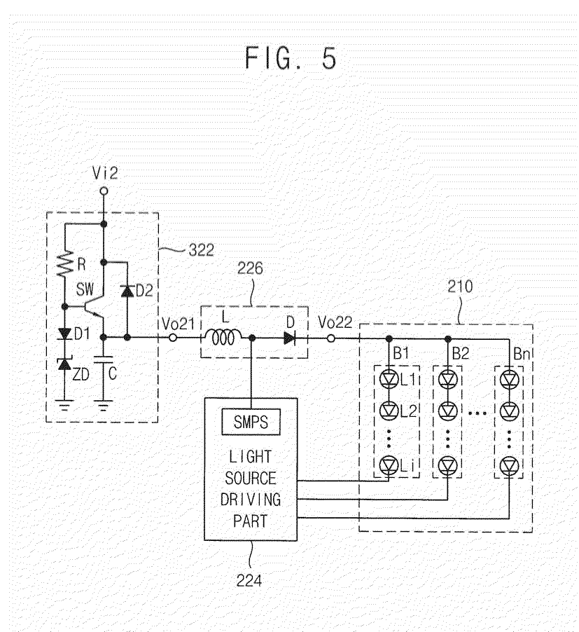

FIG. 5 is a circuit diagram illustrating a backlight assembly according to another embodiment of the present invention.

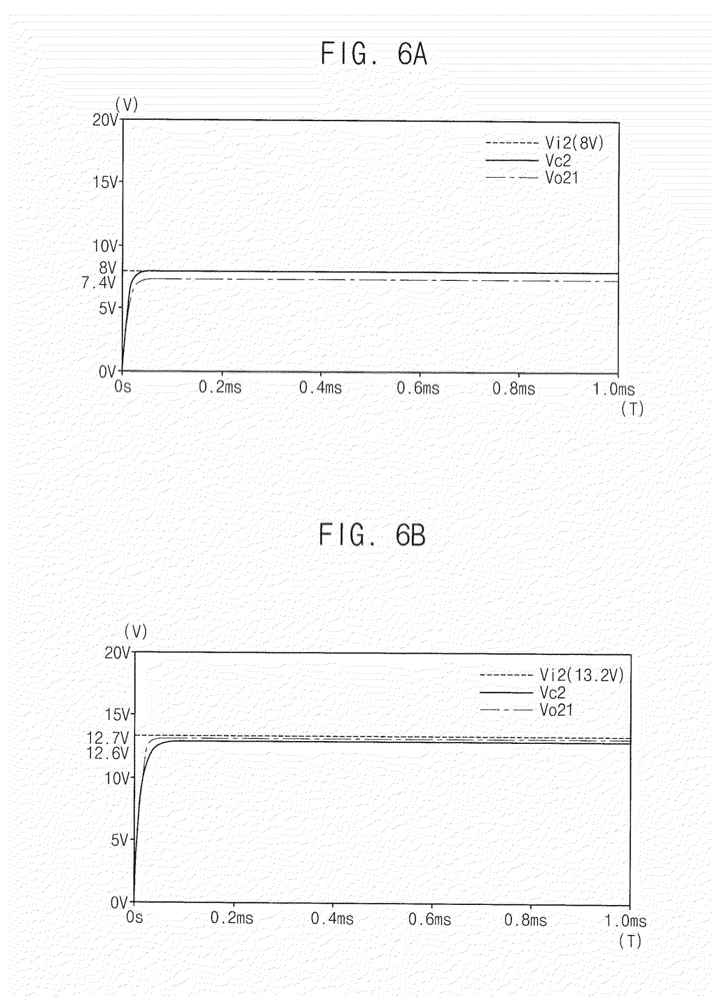

FIGS. 6A to 6C are waveform diagrams illustrating voltages applied to a control terminal, an input terminal, and an output terminal of the light source power supply part of FIG. 5 according to one or more embodiments of the present invention. In FIGS. 6A to 6C, a horizontal axis (i.e., x-axis) represents time T, and a vertical axis (i.e., y-axis) represents voltage V.

A display apparatus according to the present embodiment is substantially the same as the display apparatus according to the previous embodiment described in FIG. 2, except that a light source power supply part 322 further includes a first diode D1 and a second diode D2 so that a second DC voltage Vo21 and a third DC voltage Vo22 are different from the second DC voltage Vo11 and the third DC voltage Vo12 of the previous embodiment. Otherwise, the same reference numbers are used to designate the same elements, and descriptions of the same elements are omitted.

Referring to FIGS. 1, 5, and 6A to 6C, the first diode D1 compensates a second reference voltage Vref2 by being connected to the Zener diode ZD in series so that the second DC voltage Vo21 is close to the second reference voltage Vref2. A cathode of the first diode D1 is connected to the cathode of the Zener diode ZD, and an anode of the first diode D1 is connected to the control terminal of the switching element SW.

The light source power supply part 322 may further include the second diode D2 connected between the input terminal and the output terminal of the switching element SW. A cathode of the second diode D2 is connected to the input terminal of the switching element SW and an anode of the second diode D2 is connected to the output terminal of the switching element SW. The second DC voltage Vo21 may be closer to the second reference voltage Vref2 by the use of the second diode D2.

For example, the second reference voltage Vref2 may be greater than the breakdown voltage of the Zener diode ZD by the amount of a compensation voltage. That is, the second DC voltage Vo21 may be closer to the second reference voltage Vref2 by the use of the first and second diodes D1 and D2. In this case, the second reference voltage Vref2 may be increased to about 12.6 V. Therefore, heat generated from the light source power supply part 322 caused by a voltage drop may be reduced.

For example, in FIG. 6A, the light source input voltage Vi2 is substantially less than the second reference voltage Vref2, which is the sum of the breakdown voltage and the compensation voltage, when the light source input voltage Vi2 of about 8 V is applied to the input terminal of the switching element SW of FIG. 2. Thus, the Zener diode Zd is turned off. Therefore, a total voltage Vc2 applied to the Zener diode ZD and the first diode D1 increases for about 0.03 ms after the light source input voltage Vi2 is applied, and reaches about 8 V. The first output voltage, which is the second DC voltage Vo21, increases for about 0.03 ms after the light source input voltage Vi2 is applied, and reaches about 7.4 V.

In FIG. 6B, the light source input voltage Vi2 is greater than the second reference voltage Vref2, which is the sum of the breakdown voltage and the compensation voltage, when the light source input voltage Vi2 of about 13.2 V is applied to the input terminal of the switching element SW. Thus, the Zener diode Zd is turned on. Therefore, the total voltage Vc2 applied to the Zener diode ZD and the first diode D1 increases for about 0.03 ms after the light source input voltage Vi2 is applied, and reaches about 12.6 V, which is the second reference voltage Vref2. The second output voltage, which is the second DC voltage Vo21, also increases for about 0.03 ms after the light source input voltage Vi2 is applied and becomes close to about 12.6 V, which is the second reference voltage Vref2. In this case, the second output voltage finally becomes about 12.7 V, which is about 0.1 V greater than the second reference voltage Vref2.

In FIG. 6C, the light source input voltage Vi2 is also greater than the second reference voltage Vref2, which is the sum of the breakdown voltage and the compensation voltage, when the light source input voltage Vi2 of about 19.5 V is applied to the input terminal of the switching element SW. Thus, the Zener diode Zd is turned on. Therefore, the total voltage Vc2 applied to the Zener diode ZD and the first diode D1 increases for about 0.03 ms after the light source input voltage Vi2 is applied, and reaches about 12.6 V, which is the second reference voltage Vref2. The second output voltage, which is the second DC voltage Vo21, also increases for about 0.03 ms after the light source input voltage Vi2 is applied and becomes close to 12.6 V, which is the second reference voltage Vref2. In this case, the second output voltage finally becomes about 12.7 V, which is about 0.1 V greater than the second reference voltage Vref2.

Therefore, a difference between the second reference voltage Vref2 and the second DC voltage Vo21 is about 0.1 V, which is substantially less than a difference of about 0.5 V between the first reference voltage Vref1 and the second DC voltage Vo11 of the previous embodiment. For example, the second reference voltage Vref2 is compensated by an amount of about 0.4 V, which is the compensation voltage.

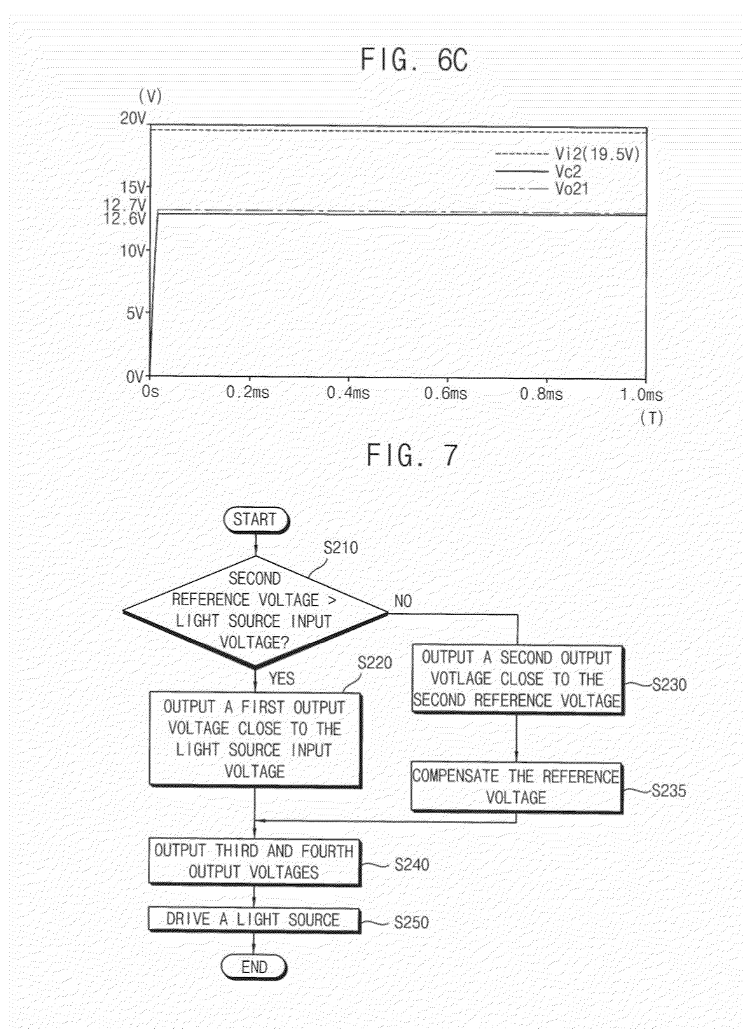

FIG. 7 is a flowchart illustrating a method of driving the light source driving apparatus of FIG. 5 according to one or more embodiments of the present invention.

Referring to FIGS. 5 and 7, the second reference voltage Vref2 and the light source input voltage Vi2 are compared when the light source input voltage Vi2 is applied to the input terminal of the switching element SW (step S210).

Then, when the light source input voltage Vi2 is found to be substantially less than the second reference voltage Vref2, the first output voltage, which is the second DC voltage Vo21 at a level close to the light source input voltage Vi2, is generated (step S220). On the other hand, when the light source input voltage Vi2 is found to be greater than or equal to the second reference voltage Vref2, the second output voltage, which is the second DC voltage Vo21 at a level close to the second reference voltage Vref2, is generated (step S230). At this time, the second reference voltage Vref2 is compensated in order to be close to the second output voltage (step S235).

The second DC voltage Vo21 is boosted into the third DC voltage Vo22, which includes the third and fourth output voltages, by the SMPS in the light source driving part 224 connected between the inductor L and the diode D of FIG. 5 (step S240). In this case, the third DC voltage Vo22 may also include the first and second output voltages. Therefore, the light source driving part 224 drives the light source part 210 based on the third DC voltage Vo22 (step S250).

According to one or more embodiments of the present invention, the light source power supply part 322 having the second reference voltage Vref2 close to the second output voltage may be generated so that a difference between the second reference voltage Vref2 and the second output voltage is reduced. Thus, a desired second output voltage may be easily outputted.

In accordance with one or more embodiments of the present invention, a second output voltage close to a reference voltage may be outputted, and may be further boosted or maintained, so that a light source may use the second output voltage for driving the display panel although the level of a light source input voltage is high regardless of the number of LEDs in the light source. Therefore, non-operating LEDs may be prevented because a variety of levels of the light source input voltages from a battery or an adapter may be boosted.

The foregoing embodiments are illustrative of the possible embodiments of the present invention and are not to be construed as limiting thereof. Although a few embodiments of the present invention have been described, those skilled in the art will readily appreciate that many modifications in form and detail are possible in the embodiments without materially departing from the spirit and scope of the present invention. Accordingly, all such modifications are intended to be included within the scope of the present invention as defined in the claims.

What is claimed is:

1. A method of driving a light source, the method comprising:
comparing a reference voltage with a light source input voltage to generate a first output voltage close to the light source input voltage or a second output voltage close to the reference voltage; and
driving the light source based on the first output voltage or the second output voltage.

2. The method of claim 1, wherein the first output voltage is generated when the light source input voltage is substantially less than the reference voltage, and the second output voltage is generated when the light source input voltage is greater than or equal to the reference voltage.

3. The method of claim 1, wherein generating the second output voltage further comprises:
compensating the reference voltage so that a difference between the second output voltage and the reference voltage is reduced.

4. The method of claim 1, further comprising:
boosting the first output voltage to generate a third output voltage; and
boosting the second output voltage to generate a fourth output voltage,
wherein driving the light source is performed based on the first output voltage, the second output voltage, the third output voltage, or the fourth output voltage.

5. A light source driving apparatus comprising:
a light source power supply part configured to compare a reference voltage with a light source input voltage to generate a first output voltage close to the light source input voltage or a second output voltage close to the reference voltage; and
a light source driving part configured to drive a light source based on the first output voltage or the second output voltage.

6. The light source driving apparatus of claim 5, wherein the light source power supply part is configured to generate the first output voltage when the light source input voltage is substantially less than the reference voltage, and to generate the second output voltage when the light source input voltage is greater than or equal to the reference voltage.

7. The light source driving apparatus of claim 5, wherein the light source power supply part comprises:
a switching element comprising an input terminal configured to receive the light source input voltage, a control terminal, and an output terminal connected to the light source driving part; and
a Zener diode comprising an anode connected to a ground terminal, and a cathode connected to the control terminal of the switching element.

8. The light source driving apparatus of claim 7, wherein the reference voltage is a breakdown voltage of the Zener diode.

9. The light source driving apparatus of claim 7, further comprising a resistor connected between the input terminal of the switching element and the control terminal of the switching element.

10. The light source driving apparatus of claim 7, further comprising a capacitor connected between the output terminal of the switching element and the ground terminal.

11. The light source driving apparatus of claim 5, wherein the light source power supply part comprises:
a switching element comprising an input terminal configured to receive the light source input voltage, a control terminal, and an output terminal connected to the light source driving part;
a first diode connected to the control terminal of the switching element; and
a Zener diode comprising an anode connected to a ground terminal, and a cathode connected to the first diode.

12. The light source driving apparatus of claim 11, wherein the cathode of the Zener diode is connected to a cathode of the first diode.

13. The light source driving apparatus of claim 11, wherein the reference voltage is a summation of a breakdown voltage of the Zener diode and a compensation voltage that is a compensation amount compensating the reference voltage by the first diode.

14. The light source driving apparatus of claim 11, wherein the light source power supply part further comprises a second diode connected between the input terminal of the switching element and the output terminal of the switching element.

15. The light source driving apparatus of claim 11, further comprising a resistor connected between the input terminal of the switching element and the control terminal of the switching element.

16. The light source driving apparatus of claim 11, further comprising a capacitor connected between the output terminal of the switching element and the ground terminal.

17. The light source driving apparatus of claim 5, further comprising:
a booster circuit configured to boost the first output voltage and the second output voltage to generate a third output voltage and a fourth output voltage, respectively,
wherein the light source driving part is configured to drive the light source based on the first output voltage, the second output voltage, the third output voltage, or the fourth output voltage.

18. The light source driving apparatus of claim 17, wherein the light source driving part comprises a switching-mode power supply (SMPS),
and wherein the booster circuit comprises:
an inductor connected between the light source power supply part and the SMPS; and
a third diode comprising an anode connected to the SMPS and the inductor, and a cathode connected to the light source.

19. A display apparatus comprising:
a display module configured to receive light to display an image; and
a backlight assembly comprising:
a light source part comprising a plurality of light source blocks to provide the display module with the light;
a light source power supply part configured to compare a reference voltage with a light source input voltage to generate a first output voltage close to the light source input voltage or a second output voltage close to the reference voltage; and
a light source driving part configured to drive the light source part based on the first output voltage or the second output voltage.

20. The display apparatus of claim 19, wherein the light source block comprises a plurality of LEDs being arranged in a longitudinal or a latitudinal direction corresponding to the display module.
